(19) United States
(12) Patent Application Publication
(10) Pub. No.: US 2002/0149619 A1
(43) Pub. Date: Oct. 17, 2002

(54) System and method for constructing a graphical user interface

(75) Inventor: Frank Sauer, Odessa, FL (US)

Correspondence Address: Gary B. Solomon, Jenkens & Gilchrist, P.C., 3200 Fountain Place, 1445 Ross Avenue, Dallas, TX, 75202-2799, US

(73) Assignee: Perot Systems Corporation

(21) Appl. No.: 09/781,924

(22) Filed: Feb. 12, 2001

(51) Int. Cl. G06F 3/00

(52) U.S. Cl. 345/762; 345/764

(57) ABSTRACT

An embodiment of the present invention includes a method and system for constructing a graphical user interface (GUI) having a plurality of graphical elements. The method includes reading a specification having non-executable information that defines a structure for the GUI. The structure forms communication connections between the graphical user elements and underlying data objects. The specification defining the structure of the GUI is parsed. The structure of the GUI defined by the specification as parsed is constructed, and the GUI having the graphical elements and the structure as constructed may be rendered. Another embodiment of the present invention includes a framework for developing the GUI. Yet another embodiment of the present invention includes a method for providing communication between at least two applications of a GUI by defining a first and second data object in a first and second application, respectively, as being promoted, and connecting the first and second data objects by a third data object residing externally from the first and second applications.

### BACKGROUND OF THE PRESENT INVENTION

1. Field of the Invention

The present invention relates generally to graphical user interfaces, and more particularly, but not by way of limitation, to a method and system for constructing a graphical user interface.

2. Description of the Related Art

Software applications that operate on computer systems generally include a graphical user interface (GUI) for human operators to interface. Because the GUI is the most “visible” part of the application, the GUI is the part of the application most frequently changed. Over the life of an application, the GUI may be changed many times, which is very labor intensive and thus costly due to the man-hours necessary to make the changes. GUI programmers understand that the difficulty of building and modifying the GUI is not so much creating the “look” or visual aspects of the GUI, but more so the operation (e.g., data handling) of the GUI. The changing of the GUI is further compounded by the trend towards personalization of the GUI by operators. This personalization drastically increases the complexity of GUI development since users may require different views based, for example, on preferences, such as security, and role of the operator.

A GUI generally includes two major components: (i) views or widgets that are visual or interactive graphical user elements, such as scroll bars, text edit boxes, and tables, displayed on the GUI, and (ii) models that provide connections between the graphical user elements for data communication between the graphical user elements and the underlying data objects. The graphical user elements are well defined in Java® or other object oriented programming languages. However, while the graphical user elements are well defined, the operability of the graphical user elements must be customized for each application. In other words, the underlying architecture that handles data and communications between the graphical user elements is customized during development and maintenance of the GUI for the application.

The underlying architecture of the GUI is presently coded using an object oriented language, such as Java®, which results in hundreds or thousands of lines of code, resulting in very time consuming and costly efforts. Additionally, because the underlying architecture is coded in an executable programming language, the code must be compiled prior to operating the GUI.

Currently, and in the past, there have been efforts to standardize the architecture or structure that interfaces the graphical user elements. These efforts have produced object models that are composed of executable code. These efforts have not achieved a level of abstraction beyond defining the object models and encapsulating the object models in a toolkit.

To more easily provide for development of the GUI, at least one contemporary effort provides for a specification that defines the graphical user elements in a content markup language. However, to connect the graphical user elements to object models to form the underlying architecture still requires customized coding for both implementation and maintenance, which means that an application programmer, even if utilizing object models from the toolkit, is still required to write code to create a working application.

### SUMMARY OF THE INVENTION

To overcome the problem of having to write code during development and maintenance of an underlying architecture of a graphical user interface (GUI), a specification defined in a content markup language is provided for a GUI development system. The specification may be written in an extensible markup language (XML) or other content markup language. By writing the specification in a non-executable language (e.g., XML), the specification may be easily written and/or modified with little or no programming. Furthermore, the GUI may be changed by simply changing the specification rather than having a programmer modify hundreds or thousands of lines of code that handles connecting graphical user elements to the underlying architecture of the GUI. Rather, the specification can be easily redefined, separate from the code, to modify the view and/or the functionality of the GUI.

An embodiment of the present invention includes a method and system for constructing a GUI having a plurality of graphical elements. The method includes reading a specification having non-executable information that defines a structure for the GUI. The structure forms communication connections between the graphical user elements and underlying data objects. The specification defining the structure of the GUI is parsed. The structure of the GUI defined by the specification as parsed is constructed. The GUI having the graphical elements and the structure as constructed may be rendered.

Another embodiment of the present invention includes a framework for developing a GUI. The framework includes a set of interactive graphical user elements. A set of connection models defining data objects that connect to the interactive graphical user elements are also available to the framework. The data objects handle data communicated between at least the interactive graphical user elements. A builder receives a specification including non-executable information that (i) defines interactive graphical user elements to be presented on the GUI, and (ii) connects the connection models coupling interactive graphical user elements. The builder further constructs the GUI based upon the specification.

Yet another embodiment of the present invention includes a method for providing communication between at least two applications of a GUI. A first data object in a first application is defined to be promoted. A second data object in a second application is defined to be promoted. The first and second data objects are connected by a third data object, where the third data object resides externally from the first and second applications.

A more complete appreciation of the present invention and the scope thereof can be obtained from the accompanying drawings which are briefly summarized below, the following detailed description of the presently-preferred embodiments of the invention, and the appended claims.

### BRIEF DESCRIPTION OF THE DRAWINGS

FIG. 1 is a representation of a framework that provides structure for a GUI according to the principles of the present invention;

FIG. 2 is an exemplary structure including interactive graphical user elements and underlying data objects according to FIG. 1;

FIG. 3 is an exemplary flow diagram describing a method for constructing the GUI according to FIGS. 1 and 2;

FIG. 4 is another exemplary structure of a GUI according to FIG. 1;

FIG. 5 is an exemplary structure that is constructed according to FIG. 1 and allows applications to communicate with other applications according to the principles of the present invention; and

FIG. 6 is an exemplary system block diagram for constructing a GUI according to FIG. 1.

### DETAILED DESCRIPTION OF THE DRAWINGS

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Creating and maintaining a graphical user interface (GUI) for a software application includes designing a view or image for displaying to a user of the GUI and underlying data objects or ValueModels for handling data entered and/or displayed on the GUI. The view includes interactive graphical user elements or widgets, and the underlying data objects include models that are predefined to handle data in certain ways. The widgets are connected to the data objects so that data received and/or displayed by the widgets is handled by the data objects.

A framework includes predefined widgets and data objects for GUI developers (e.g., software programmers) to construct the GUI. To access the widgets and data objects, the GUI developer forms a subclass in the application that inherits behaviors to find and manipulate the widgets and the data objects from the framework.

To utilize the widgets and the data objects, the GUI developer creates a specification using a content markup language, such as an extensible markup language (XML). The specification is received by a GUI builder package, which is included with the framework, that interprets the specification and constructs the GUI by connecting the data objects to the widgets. The specification may be interpreted by the builder at run-time upon rendering of the GUI. It should be understood that the specification is not executable software code, such as Java®.

Because the specification defines the connections or structure of the GUI from predefined data objects, the conventional process of writing code to handle data for the GUI is substantially eliminated as the specification replaces the code. In other words, the specification defines the widgets and the data objects connected to the widgets and the builder constructs the GUI. To modify the GUI, the specification may be simply modified, which saves the GUI developer from having to modify or rewrite software code that displays a new look or operation of the GUI operation.

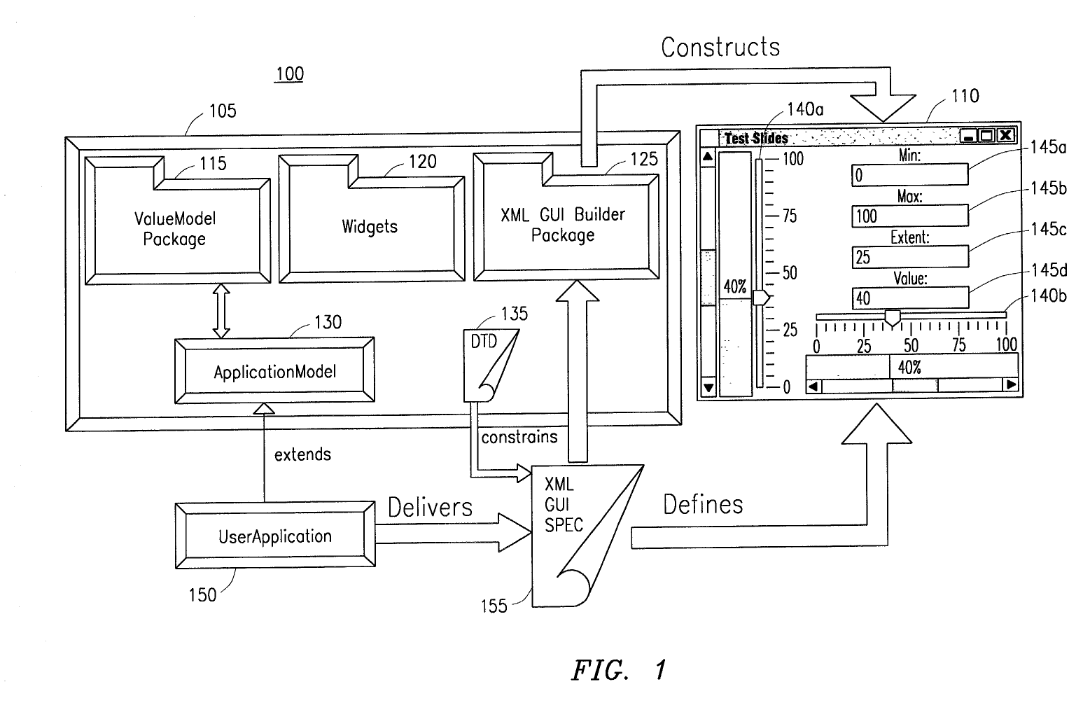

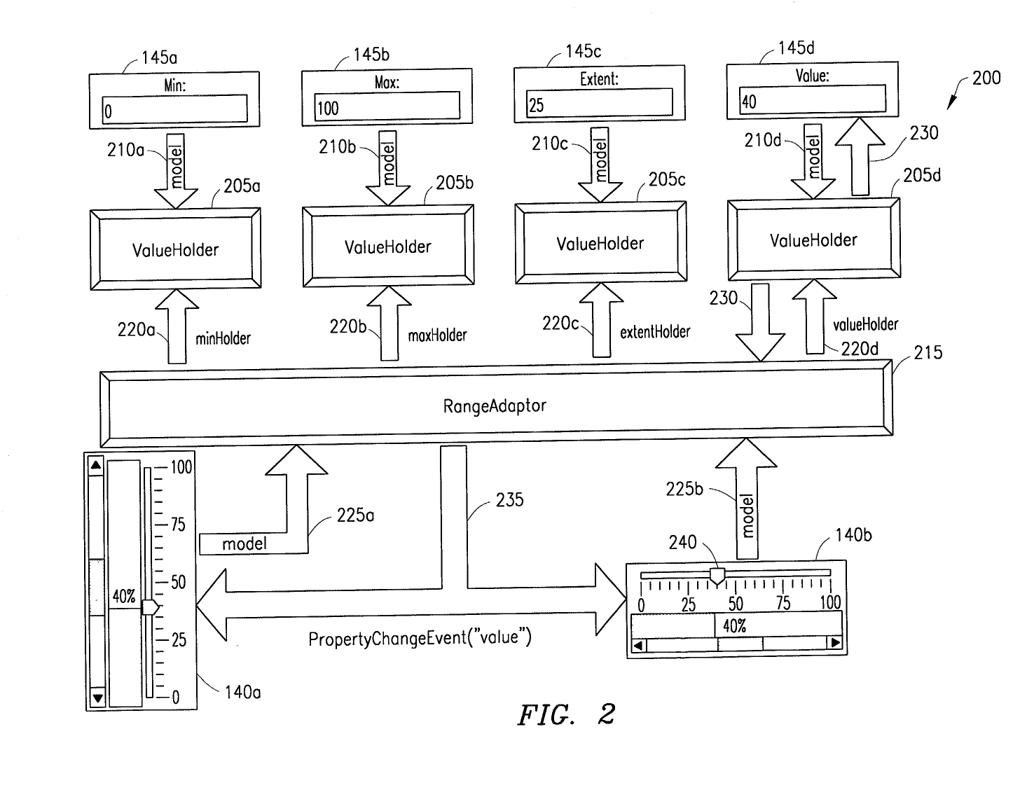

FIG. 1 is a representation 100 of a framework 105 that provides structure for a graphical user interface 110 according to the principles of the present invention. The framework 105 includes a ValueModel package 115, widgets 120, a GUI builder package 125, an ApplicationModel 130, and a document type descriptor (DTD) 135. The widgets 120 are a set of interactive graphical user elements, such as sliders 140a and 140b and data entry fields 145a-145d, for example, that are displayed on the GUI 110. The ValueModel package 115 includes a set of data objects that connect the interactive graphical user elements. The data objects are further herein described with regard to FIG. 2.

A UserApplication 150 (i.e., software application having a GUI) utilizes the framework 105 to produce the GUI 110. To have access to the ValueModel package 115 and the widgets 120, the UserApplication 150 includes a class that extends the ApplicationModel 130, which causes the UserApplication 150 to gain access to the behavior of the predefined models (i.e., ValueModels 115 and widgets 120) in the framework 105. A GUI specification 155 (hereinafter “specificatio”) includes non-executable information that defines a view and structure for the GUI 110.

To construct the GUI 110, the application 150 notifies the framework 105 of the existence of the specification 155. The framework 105 utilizes the document type descriptor 135 to ensure that the specification 155 includes proper grammar for defining the GUI 110. The GUI builder package 125 receives the specification 155, optionally validates the specification 155, and constructs the view and underlying data objects defined within the specification 155. In other words, the GUI 110 is constructed from the specification 155 by the GUI builder package 125 (i) rendering the image (i.e., views), and (ii) connecting the underlying data objects to the widgets to provide functionality for the GUI 110.

To construct the GUI 110, the GUI builder package 125 interprets the specification 155 at run-time. The interpretation of the specification 155 can be performed at run-time as the specification 155 is non-executable information (e.g. XML code). Alternatively, the interpretation of the specification 155 may occur before run-time and the structure of the GUI 110 can be stored to be loaded at run-time. The specification 155 is separate from a program written in Java® or another high-level computer language. Because the specification 155 is separate, contents of the specification 155 may be altered without having to modify the UserApplication 150. And, because the specification 155 specifies the construction of the GUI 110 to the GUI builder package 125, conventional construction (i.e., programming) of the GUI 110 that uses hundreds or thousands of lines of code does not have to be written.

To better understand the operation of the framework 105, and the construction of the GUI 110, an example application is presented in FIG. 2, which shows an exemplary structure 200, including interactive graphical user elements (e.g., 140 and 145) and underlying data objects (e.g., ValueHolder 205a). The interactive graphical user elements 140a and 140b are sliders. In this example, the sliders 140a and 140b are defined to be synchronized (i.e., moving one causes the other one to be moved simultaneously). The interactive graphical user elements 145a-145d are input entry fields that define the minimum, maximum, extent, and value of the sliders 140a -140b. For example, typing a value in the input entry field 145d labeled “value” causes each of the sliders 140a-140b to move to the value entered into the input field 145d.

The underlying data objects of this structure 200 include data objects 205a-205d, called ValueHolders. The ValueHolders 205a-205d are connected or coupled to the input fields 145a-145d, respectively, via object models 210a-210d, which are pointers from the interactive graphical user elements 145a-145d to the ValueHolders 205a-205d, respectively. Another data object, RangeAdaptor 215, is coupled to the ValueHolders 205a-205d via object models 220a-220d. The RangeAdaptor is further connected to the sliders 140a-140b via models 225a and 225b.

The structure 200 of the GUI 110 functions in the following exemplary manners. Upon an entry into the input field or widget 145d (i.e., a value of 40), a “PropertyChangeEvent( )” so event is generated by the ValueHolder 205d upon receiving the entry, which indicates that the value of ValueHolder 205d has changed. The RangeAdaptor 215 receives the event via event 230 from the ValueHolder 205d, and issues an event 235 to indicate that the value of RangeAdaptor 215 has changed. The event 235 (i.e., PropertyChangeEvent(“value”)) is received by the sliders 140a and 140b, which causes the sliders 140a and 140b to change to position 40. If, for example, one slider (e.g., 140b) has its value changed by a user of the GUI 110 “grabbing” slider element 240, the slider 140b issues an event to the RangeAdaptor 215, which, in turn, issues an event to the sliders 140a-140b and the ValueHolders 205a-205d. The ValueHolders 205a-205d, in turn, issue events to the widgets 145a and 145d, respectively, to change the value displayed in the input fields. Note, however, only the value stored in ValueHolder 205d changes in this case.

The structure 200 shows the interrelationship between interactive graphical user elements (i.e., widgets) and the underlying data objects or ValueModels (e.g., ValueHolders 205a-205d and RangeAdaptor 215). The interrelationship of the structure 200 is defined by the non-executable information in the specification 155. The ValueModels may be created by the following exemplary XML code:

<MODELS>

<VALUEHOLDER name=“min”/>
<VALUEHOLDER name=“max”/>
<VALUEHOLDER name=“extent”/>
<VALUEHOLDER name=“value”/>
<RANGEADAPTOR name=“range”

extentholder=“extent”
maxholder=“max”
minholder=“min”
valueholder=“value”/>

</MODELS>

The XML code defines four ValueHolder data objects and one RangeAdaptor data object. The RangeAdaptor data object refers to the ValueHolder data objects by their name (i.e., “extent”, “max”, “min”, and “value”). Each of these data objects are of an abstract class called ValueModel, where a ValueModel is defined as an invisible Java® bean with a single bound property of type Object named “Value”. In other words, a ValueModel is an object that has a getvalue( ) method and a setValue(Object) method with the capability of issuing a PropertyChangeEvent(“value”) each time the setValue(Object) is called. Each of the ValueModels and widgets defined in the specification 155 can receive the events if connected, directly or indirectly, to the data object issuing the event.

In addition to the models created by the XML code, exemplary XML code showing slider and input field definitions are shown below.

<VIEWS>

<VIEW name=“main” title=“Test Slider”>

.
.
.

<SLIDER name=“slider_vert” model=“range”

orientation=“VERTICAL” labels=“true” ticks=“true”
track=“true” major=“25” minor=“5” filled=“true”
snap=“true”>

<CONSTRAINTS>

<GRIDBAG fill=“VERTICAL” weight=“1.0”
gridheight=“REMAINDER”/>

<CONSTRAINTS>
</SLIDER>

.
.
.

<INPUTFIELD name=“f2” model=“max” decimalformat=“###”
type=“Integer”>
<CONSTRAINTS>

<GRIDBAG gridwidth=“REMAINDER”/>

</CONSTRAINTS>
<INPUTFIELD>

.
.
.

</VIEW>

</VIEWS>

Those skilled in the art will recognize that these widgets are subclassed widgets from Swing™, which is a user interface development kit that comes with Java®. Swings™ widgets do not inherently recognize ValueModels, so subclassing or wrapping of the Swing™ models is necessary to provide “glue” for the widgets. It should be understood that the principles of the present invention could utilize predefined widgets or underlying data objects other than those herein discussed.

As gleaned from the XML code, creating the structure 200 for the GUT 110 merely requires a GUT developer to define the widgets and the ValueModels connected to the widgets using non-executable information. The non-executable information can be stored in a file or generated real-time (i.e., dynamically) to generate the GUT 110. For example, a GUT can be generated upon a user logging into an account, where parameters that describe the user, such as a “superuser”, is generated and sent directly to the GUT builder package 125 for constructing the GUT 110.

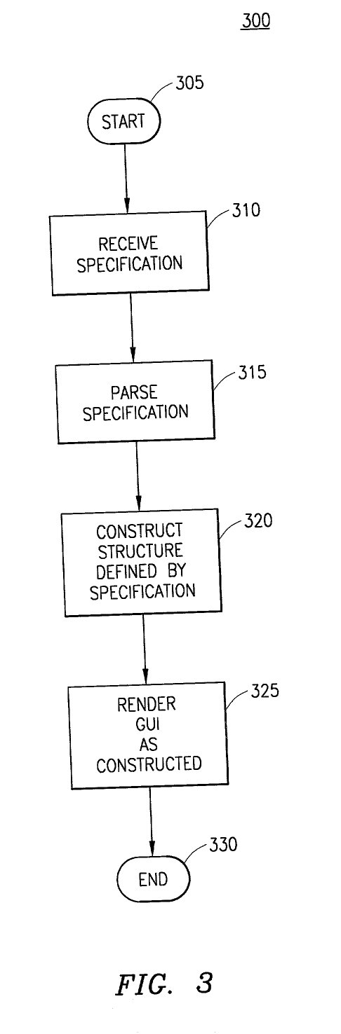

FIG. 3 is an exemplary flow diagram 300 describing a method for constructing the GUT according to FIG. 1. The method starts at step 305. At step 310, the specification 155 containing non-executable information that defines the interactive graphical user elements and the data objects to be connected to the graphical user elements is received. The specification 155 is parsed at step 315. The parsing 315 includes verifying that the non-executable information (e.g., XML code) conforms to the constraints of the document type descriptor 135. The parsing 315 may be performed by interpreting the non-executable code so that the non-executable code can be modified “off-line”. Alternatively, the parsing 315 may be interpreted prior to execution of generating the GUI 110 to improve execution rates.

At step 320, the structure 200 defined by the specification 155 is constructed. The construction 320 includes connecting the interactive graphical user elements with the associated underlying data objects. In general, the construction 320 is performed sequentially in a top-down fashion, however, the construction 320 could be performed bottom-up or in any other ordering. The construction may be performed serially or in parallel.

At step 325, the GUI 110 as constructed is rendered (i.e., displayed). The rendering 325 displays the views that include the interactive graphical user elements having data displayed as predefined by the values stored or initialized in the ValueModels (e.g., ValueHolder 205d). At step 330, the method for constructing the GUI 110 ends.

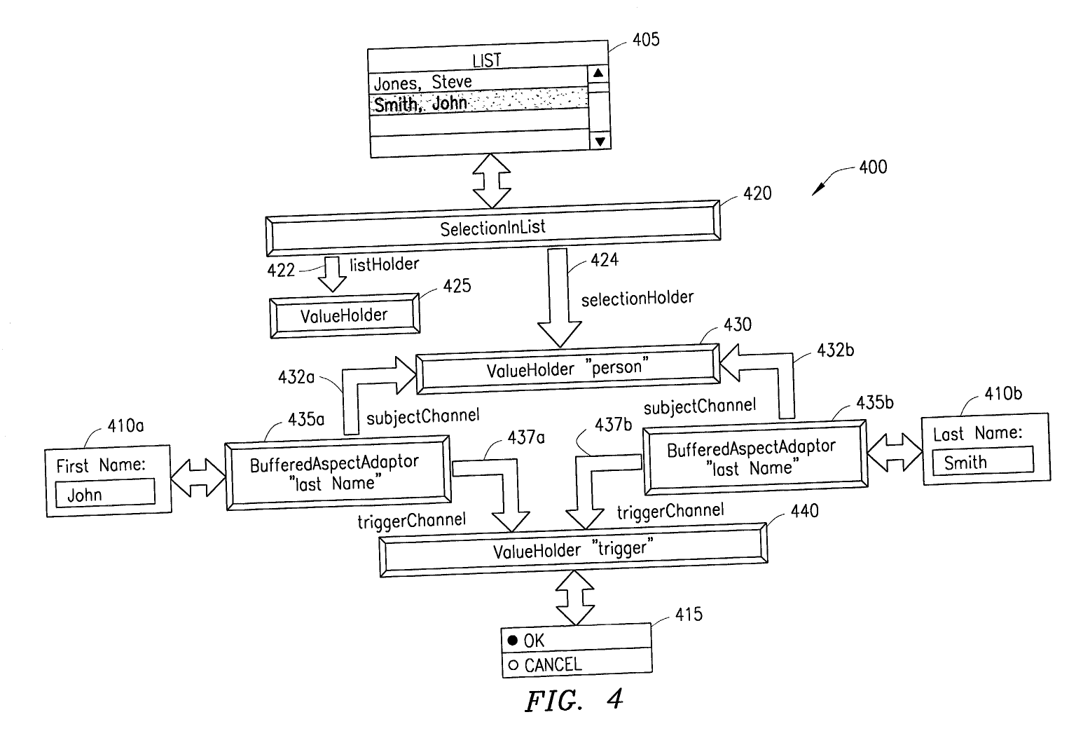

FIG. 4 is another exemplary structure 400 of a GUI according to the principles of the present invention. Similar to the structure 200 of FIG. 2, there exists both interactive graphical user elements 405, 410a-410b, and 415, and ValueModels 420, 422, 424, 425, 430, 435a-435b, 437a-437b, and 440, where the widgets are connected to the ValueModels for storing and communicating information being applied to the widgets. Typically, a GUI utilizes information entered in one widget of the GUI in a different widget of the GUI. One such example of information that is typically utilized in different parts of the GUI is a name, where a list of names displays all names entered individually into input fields.

The widget 405 is a ListBox that displays information in a list format. There exists multiple rows for displaying information separately in a row format. In the present example, separate names (e.g., “JONES, STEVE” and “SMITH, JOHN”) are listed in separate rows. The data object 420 is a SelectionInList object that allows a user to select one element in the ListBox 405. As indicated, the name “SMITH, JOHN” has been selected in the ListBox 405. Two ValueModels, listHolder 422 and selectionHolder 424, are connected to SelectionInList 420. The listHolder model 422 is used to store the list of items in the ValueHolder 425, while the selectionHolder model 424 is used to store the currently selected item (i.e., “SMITH, JOHN”) in the ValueHolder 430.

The ValueHolder 430 is connected by two related models, subjectChannel 432a and 432b, which interface to two models, BufferedAspectAdaptor 435a and 435b, respectively. The BufferedAspectAdaptor models 435a and 435b are connected to the interactive graphical user elements 410a and 410b, respectively. Additionally, the BufferedAspectAdaptor models 435a and 435b are connected to triggerChannel models 437a and 437b, which interface to ValueHolder model 440. The ValueHolder 440 is connected to the widget 415 that displays a pair of interactive buttons, “OK” and “CANCEL”.

In operation, the structure operates to display a list of names in the ListBox 405 and provide for entry/edit of the names in the input fields 410a and 410b. For example, when a first name is entered into the input field 410a, such as “JOHN”, an event (e.g., setvalue( )) is issued and the BufferedAspectAdaptor 435a receives and buffers the first name until a trigger is received by BufferedAspectAdaptor 435a via triggerChannel 437a as a result of being “triggered” by an “OK” being entered into the widget 415 by the operator of the GUI. Upon the BufferedAspectAdaptor 435a receiving the trigger, the first name being buffered is communicated to widgets and data objects directly or indirectly connected to BufferedAspectAdaptor 435a via a setValue( ) message. It should be understood that the focus of the principles of the present invention is not necessarily the structure 400 itself, but rather defining and constructing of the structure (e.g., 400) using the specification containing non-executable information. Furthermore, other widgets and data objects not shown in the exemplary drawings are contemplated by the principles of the present invention.

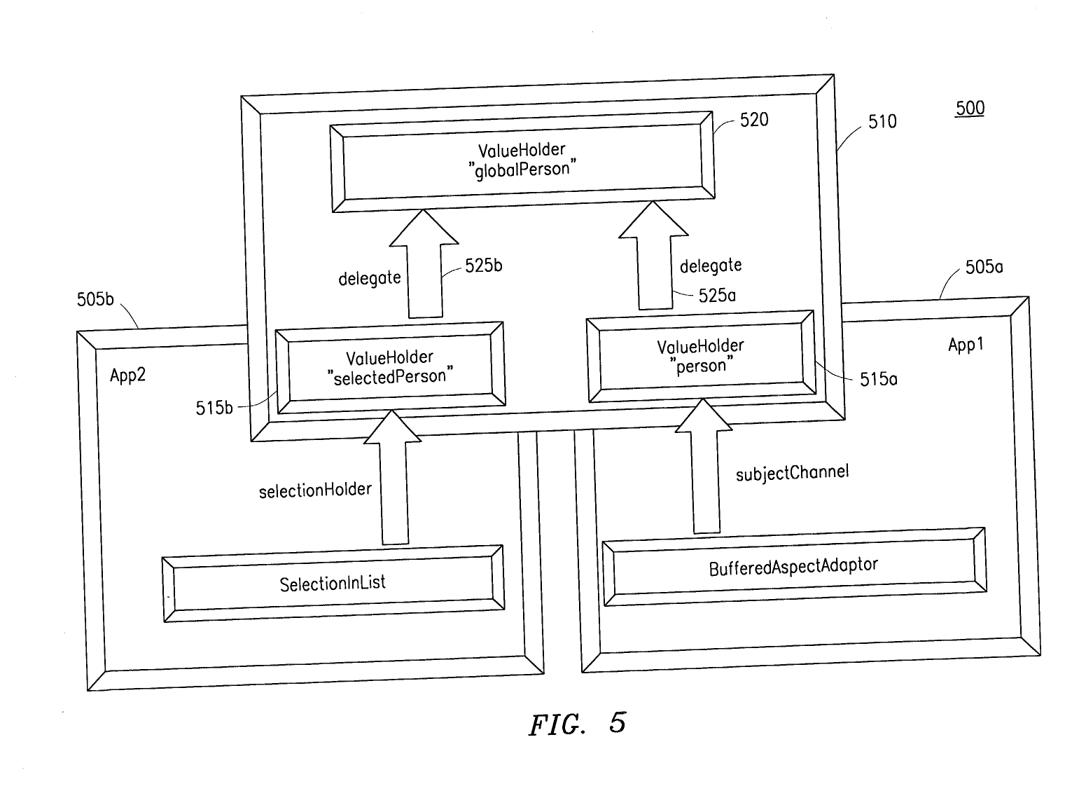

FIG. 5 is an exemplary structure 500 that is constructed according to FIG. 1, and allows applications 505a and 505b to be reusable as components of other applications 505b and 505a, respectively, according to the principles of the present invention. Ideally, a component being reused has no knowledge about an enclosing application 510 or other components embedded in the enclosing application. To provide for communication between applications (e.g., 505a and 505b) without knowledge of each other, a ValueModel (e.g., ValueHolder 515a) may be set as a promoted model from the first application 505a by simply turning on a “promote” flag, which may be boolean type as shown below:

<VALUEHOLDER name=“person” promote=“true”/>The promote flag publishes the ValueHolder 515a to the enclosing application 510, which makes the value (i.e., “person”) stored in the ValueModel 515a available to the enclosing application 510. Similarly, ValueHolder 515b from the second application 505b may be promoted to allow for other widgets or objects to utilize a selected person, for example, from a list as stored in ValueHolder 515b by the non-executable information of the specification, which is XML code, as shown below:

<VALUEHOLDER name=“selectedPerson” promote=“true”/>

<SELECTIONINLIST name=“persons” selectionHolder=“selectedPerson”/>At this point, the enclosing application 510 has two promoted ValueModels 515a and 515b. The enclosing application 510 can now connect the ValueModels 515a and 515b together into a ValueModel 520, defined as “globalPerson”, with two delegate models 525a and 525b, as follows:

<VALUEHOLDER name=“globalPerson”

delegatefor=“app1.person,app2.selectedPerson”/>

The value of the “delegatefor” attribute indicates that the “globalperson” ValueHolder 520 serves as a delegate for the promoted “person” ValueHolder 515a in the application 505a and for the promoted “selectedperson” ValueModel 515b in application 505b. As a result of the connection, the three ValueHolders 515a, 515b, and 520 (i.e., “person”, “selectedPerson”, and “globalPerson”, respectively) behave as if they are one and the same ValueModel object. In other words, when the value of one of them changes, the value of the other two change automatically, thereby allowing applications to communicate with each other without knowing that others exist. It should be noted that while the structure components with respect to FIGS. 2 and 4 were not necessarily considered to be included in the principles of the present invention, the ability to form the enclosing application 510 via delegate ValueModels (e.g., 515a and 515b) is considered to be included in the principles of the present invention.

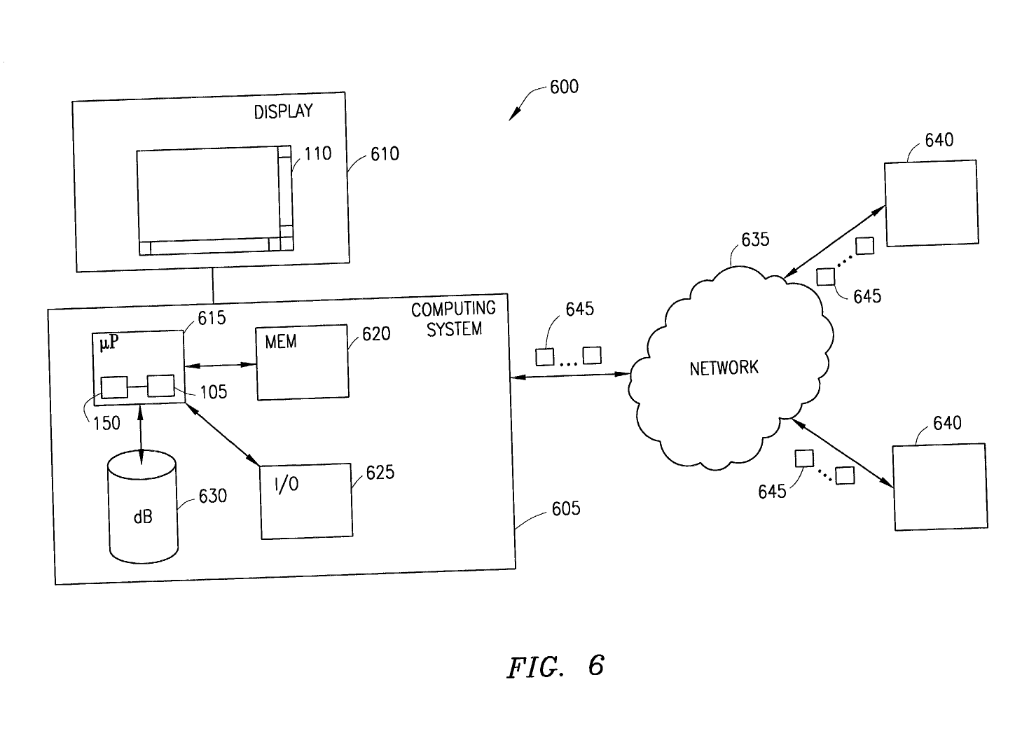

FIG. 6 is an exemplary system block diagram 600 for constructing a GUI according to FIG. 1. The system 600 includes a computing system 605 and a display 610. The computing system 605 includes a processor 615 coupled to a memory 620. The processor 615 is further coupled to an input/output module 625 and a database 630. It should be understood that the processor 615 may include several processors configured to construct the GUI 155.

The processor 615 operates the UserApplication 150 and the framework 105. As discussed with respect to FIG. 1, the application 150 inherits properties of the framework 105 so that the interactive graphical user elements (i.e., widgets) and underlying data objects can be utilized in constructing the GUI 110. The framework receives the specification (not shown) that defines the construction of the GUI 110. The application 150 and the framework 105 may be stored in the database 630 and read into the memory 620 during operation.

The computing system 605 may be connected to a network 635, which has other computing systems 640 connected to the network 635. The computing systems 605 and 640 may communicate across the network 635 via data packets 645. Applications can be deployed to a large number of computing systems 640 while maintaining centralized control of the GUI 110 in central repository or database 630. By maintaining centralized control of the GUI 110, a change to the GUI 110 does not require a complete redeployment to all computing systems 640, unless actual application code is changed. The bulk of the code in a UserApplication 150 utilizing the principles of the present invention is the framework 105 itself, which seldom changes. The framework 105 is deployed once, while UserApplications 150 are redeployed as needed. Most changes to the UserApplication 150 occur in the specification 155 (FIG. 1), which does not require redeployment of the UserApplication 150.

The previous description is of a preferred embodiment for implementing the invention, and the scope of the invention should not necessarily be limited by this description. The scope of the present invention is instead defined by the following claims.

What is claimed is:

1. A method for constructing a graphical user interface (GUI) having a plurality of graphical elements, said method comprising:
receiving a specification having non-executable information that defines a structure for the GUI, the structure forming communication connections between the graphical user elements and underlying data objects;
parsing the specification defining the structure of the GUI; and
constructing the structure of the GUI defined by the specification as parsed.

2. The method according to claim 1, wherein the specification includes extensible markup language (XML).

3. The method according to claim 1, wherein the parsing of the specification occurs at run-time.

4. The method according to claim 1, wherein the interaction includes handling data displayed by at least one graphical user element.

5. The method according to claim 1, wherein the connections provide for interactions to occur during operation of the GUI.

6. The method according to claim 1, further comprising:
rendering the GUI having the graphical elements and the structure as constructed.

7. A framework for developing a graphical user interface (GUI), said application comprising:
a set of interactive graphical user elements;
a set of connection models defining data objects that connect to the interactive graphical user elements, the data objects handling data communicated between at least the interactive graphical user elements; and
a builder for receiving a specification including non-executable information that (i) defines graphical user elements to be presented on the GUI and (ii) connects the connection models coupling the graphical user elements, said builder further constructing the GUI based upon the specification.

8. The framework according to claim 7, wherein the specification includes extensible markup language (XML).

9. The framework according to claim 7, wherein said builder further interprets the specification at run-time.

10. The framework according to claim 9, wherein the specification includes extensible markup language (XML).

11. The framework according to claim 7, further comprising a document type descriptor that defines syntax for the non-executable information.

12. The framework according to claim 7, wherein said application resides on a network of computing devices.

13. The framework according to claim 12, wherein each computing device interfaces with said application.

14. The framework according to claim 12, wherein only one of said application resides on the network.

15. The framework according to claim 12, wherein a plurality of specifications reside in a central repository on the network.

16. A system for developing a graphical user interface (GUI), said system comprising:
means for generating interactive graphical user elements for the GUI;
means for generating connections between the interactive graphical user elements, the connections, defined by non-executable information, providing data communication channels between the interactive graphical user elements and underlying data objects; and
means for building an architecture including the interactive graphical user elements and the connections between the interactive graphical user elements, said means for building utilizing said means for generating interactive graphical user elements and said means for generating connections.

17. A computer program product comprising:
a computer usable medium for storing data; and
a set of computer program instructions embodied on the computer usable medium, including instructions for:
receiving a specification having non-executable information that defines a structure for the GUI, the structure forming communication connections between the graphical user elements and underlying data objects;
parsing the specification defining the structure of the GUI; and
constructing the structure of the GUI defined by the specification as parsed.

18. The computer program product according to claim 17, wherein the specification includes extensible markup language (XML).

19. The computer program product according to claim 17, wherein the parsing of the specification occurs at run-time.

20. The computer program product according to claim 17, wherein the interaction includes handling data displayed by at least one graphical user element.

21. The computer program product according to claim 17, wherein the connections provide for interactions to occur during operation of the GUI.

22. The computer program product according to claim 17, further comprising instructions for:
rendering the GUI having the graphical elements and the structure as constructed.

23. A method for providing communication between at least two applications of a graphical user interface (GUI), said method comprising:
defining a first data object in a first application as being promoted;
defining a second data object in a second application as being promoted; and
connecting the first and second data objects by a third data object, the third data object residing externally from the first and second applications.

24. The method according to claim 23, wherein the defining includes setting a flag to a selected state.

25. The method according to claim 23, wherein the defining and connecting are performed by non-executable information.

26. The method according to claim 25, wherein the non-executable information is a content markup language.

27. A computer program product comprising:
a computer usable medium for storing data; and
a set of computer program instructions embodied on the computer usable medium, including instructions for:
defining a first data object in a first application as being promoted;
defining a second data object in a second application as being promoted; and
connecting the first and second data objects by a third data object, the third data object residing externally from the first and second applications.

28. The computer program product according to claim 27, wherein the computer program instructions are non-executable.

29. The computer program product according to claim 27, wherein the computer program instructions are an extensible markup language (XML).

30. The computer program product according to claim 27, wherein the first and second applications are contained within a third application, the third data object residing within the third application.

31. The computer program product according to claim 27, wherein at least three data objects are defined as being promoted, the at least three data objects being connected to the third data object residing externally.

32. The computer program product according to claim 31, wherein at least three data objects reside in at least three applications.
